(19) United States
(12) Patent Application Publication
(10) Pub. No.: US 2010/0062169 A1
(43) Pub. Date: Mar. 11, 2010

(54) COATING HIGH TEMPERATURE PARTS WITH POLYMER

(75) Inventor: Daniel PIERRE, Arlington Heights, IL (US)

Correspondence Address: MOTS LAW, PLLC, 1629 K STREET N.W., SUITE 602, WASHINGTON, DC, 20006-1635, US

(73) Assignee: JN Machinery, Bensenville, IL (US)

(21) Appl. No.: 12/555,690

(22) Filed: Sep. 8, 2009

Related U.S. Application Data
(60) Provisional application No. 61/095,169, filed on Sep. 8, 2008.

(51) Int. Cl. B05D 3/00; B05C 5/00

(52) U.S. Cl. 427/388.1; 118/696

(57) ABSTRACT

Devices and methods described herein operate with high temperature parts, such as heated metal parts obtained from a furnace via a conveyer. For example, in an embodiment, heated parts are coated with a coating solution by spraying the solution onto the parts without a quenching process. Methods and devices in embodiments allow cutting the volume of coating solution required for coating parts. Further, by not quenching the heated parts, heat remaining in the parts after coating process can be utilized for subsequent heat-requiring steps. Further, dispensing flow rate of the coating solution can be adjusted by a pump, thereby controlling coating density and temperature of the parts. Coated parts can dry without forced air, additional heat, or additional time. This allows a secondary operation shortly after the coating process, for which a dry surface is required.

### CROSS REFERENCE TO RELATED APPLICATIONS

This application claims priority based on 35 USC 120 from prior U.S. Provisional Patent Application No. 61/095,169 filed on Sep. 8, 2008, entitled “Coating High Temperature Parts with Polymer”, the entire contents of which are incorporated herein by reference.

### FIELD OF THE INVENTION

The invention relates to chemical treatments of metal parts and particularly to paint protection of parts during or after heat treatment.

### BACKGROUND

Industrial parts such as metal springs often need a chemical coating for protection from corrosion and for imparting aesthetic properties. Such coated objects can be made from metals such as steel, iron, aluminum, or the like, or from other materials such as wood, ceramic, plastic or paper. U.S. Pat. No. 5,283,280, issued to Whyte, describes such a coating process wherein an aqueous bath that contains a polymer solution is heated to about 80-160 degrees F. for coating. A metal object is heated to about 220-1700.degree. F. and immersed in the bath, causing a polymer coating to form on the surface of the object. Examples of suitable polymer solutions include those containing water-reducible alkyd resins, acrylic polymers, urethanes, multi-functional carbodiimides, melamine formaldehyde resins, styrene-acrylic copolymers, and polyolefin waxes. The coating compositions described in Whyte are most particualarly incorporated by reference in their entireties.

Aqueous polymer coatings useful for coating objects also are taught in U.S. Pat. Nos. 5,458,659; 5,605,722; 5,605,952; 5,605,953; and 5,609,965; all of which are issued to Esser. These patents teach applying protective coatings or aesthetic finishes on various substrates. The compositions taught therein are specifically incorporated by reference.

The technique of adding coating solution to hot metal parts has been used extensively, especially in the spring manufacture industry. However, the procedure used typically is very wasteful and inconvenient. The Whyte technique of dunking hot metal parts into a bath of paint is inefficient for several reasons. The bath requires a large volume to accommodate immersion of parts, such immersion cools the parts down so far that typically the parts need extra time and/or heating to get the polymer to set, and heat from the parts is transferred to the dunking bath, which then usually has to be cooled by another process.

Yet other problems arise from implementation of the dunking method. A large quantity of coating material has to be shipped to and handled by the end user. To minimize shipping costs, the coating material typically is made into a suspension by the paint manufacturer, and shipped in a concentrated form, after which the material is diluted with water, all while maintaining the polymer in suspension or solution. The original material has to remain stabile for a long time (typically a year or more) so that dilution and use can occur after shipping and prolonged storage. Chemical ingredients and conditions are chosen to maintain good long term stability, particularly since the compositions are used in a large bath that is exposed to heated parts over a long time period. The constantly re-used material cannot be thrown out but is expected to have a long service life after dilution.

### SUMMARY

Embodiments alleviate the shortcomings described above in several respects. One object is to drastically slash the volume of coating solution needed to coat parts. Another object is to limit heating of the coating solution during use. Yet another object is to provide real time or almost real time control of coating density of parts. Yet another object is to provide a dried coat on parts without necessarily having to use forced air, additional heat or additional time to achieve drying. Another object is to provide coated parts that still have enough internal/residual heat remaining after coating, so that a subsequent heat requiring step, such as a secondary process (addition of lubricant, stencil marking, coating with organic solvent based coating etc), can quickly follow (eg. After less than 1 min, 30 seconds, less than 15 seconds) without additional heat input. Yet another object is to achieve a coating that is sufficiently dried to allow a secondary operation in line and within seconds of the coating process. Such secondary process may be, for example, a salt spray protection coating, a striping or coating, or printing of part numbers or other information on the part, or other process in which a dry surface is required such as immediate manual handling of the parts.

Still other objects will be appreciated from a review of this disclosure and of the references that are specifically incorporated by reference.

One embodiment is an apparatus for coating heated metal parts without quenching, comprising a conveyor of metal parts from an oven, the metal parts preferably having mean temperatures between 300 and 500 degrees Fahrenheit a source of aqueous polymer solution, a dispenser fluidically connected to the polymer solution, the dispenser positioned to coat at least most of the outside surfaces of the metal parts, and a pump for moving the aqueous polymer solution through the dispenser at a controlled flow rate, wherein the pump is controlled to dispense polymer solution onto the heated metal parts at a rate that cools the metal parts less than 100 degrees Fahrenheit until a dry state.

In an embodiment the apparatus has an aqueous polymer solution that comprises a polyanionic polymer at a concentration of at least 2% weight/volume, and a volatile base. In another embodiment, the polymer comprises acetoacetoxy-type functional moieties and the polymer solution further comprises amine-functional moieties. In yet another embodiment, the volatile base is selected from the group consisting of dimethylamino hydroxypropane, amino methyl propanol, dimethyl amino methyl propanol, dimethyl amino ethanol, diethyl amino ethanol, morpholine, polyethyleneamine and triethanolamine. In an embodiment the apparatus further comprises a catch basin located below the dispenser and positioned to collect overspray. The apparatus also may comprise a second, non-aqueous solvent based polymer solution and a second dispenser fluidically connected to the second polymer solution and positioned to dispense the second polymer onto the metal parts after they have dried. The dispenser may be a spray curtain and the aqueous polymer solution may comprise a volatile base that buffers the solution with a pKa below 9. In an embodiment, the metal parts have mean temperatures between 300 and 500 degrees Fahrenheit. The aqueous polymer solution may comprise a stryrine acrylic polymer and a volatile base.

Another embodiment is a method for coating heated metal parts without quenching them, comprising: providing hot metal parts at mean temperatures between 300 and 700 degrees Fahrenheit via a conveyor; spraying the metal parts with a coating solution comprising an aqueous polymer and a volatile base; and allowing the parts to air dry, wherein the spray density and conveyor movement allows cooling the parts by less than 50 degrees Fahrenheit while air drying. In yet another embodiment the hot metal parts are provided at mean temperatures of between 400 and 550 degrees Fahrenheit. The coating solution may comprise a polyanionic polymer at a weight to volume ratio of between 0.5 to 15 percent, and a volatile base and the volatile base may be a non-ammonia buffer compound with a pKa less than pH 10. In another embodiment the spraying step comprises dropping the parts through a waterfall curtain or ring tube. In an embodiment the waterfall curtain is positioned at an intersection between a first conveyor that brings the metal parts from a furnace and a second conveyor positioned horizontally below the first conveyor. In an embodiment the conveyor speed and the spraying volume are manually controlled individually. In an embodiment, the conveyor comprises two parallel conveyors with a small gap between them that is small enough to prevent the parts from falling out. The gap size may be between 0.1 and 0.5 times the mean part diameter size, with respect to the horizontal movement axis of the part on the conveyor. In an embodiment, the method further comprises use of a computer with a stored program that controls at least conveyor speed or spraying volume rate, and which accepts user input to select an optimum speed or volume rate that corresponds with a part type.

Another embodiment is an apparatus for coating heated metal parts, comprising: an oven; a conveyor for receiving metal parts from the oven, comprising a coating station that has at least one spray nozzle or curtain for administering adhesion fluid to parts that fall on or that have been placed on the conveyor; a reservoir and one or more lines that fluidically connect the reservoir to the coating station; a drain in the coating station for returning excess fluid to the reservoir; wherein the reservoir holds an aqueous adhesion fluid that comprises a polymer and a volatile base. The oven may have a temperature control capable of controlling heat to metal parts that exit the oven at 450 degrees Fahrenheit. The coating station may apply adhesion fluid at a rate that lowers the metal part temperature by less than 50 degrees Fahrenheit. The apparatus may comprise two conveyor belts in parallel that have a space between them to facilitate evenness of coating. The space may be between 1 and 10 inches wide in an embodiment. In an embodiment the polymer is a polyanion. The polymer may be carboxylated.

In an embodiment the apparatus further comprises a second coating station located downstream from the coating station, wherein the second coating station comprises a reservoir of non-aqueous coating fluid. In an embodiment the apparatus further comprises a spray curtain for treating metal parts that fall onto the conveyor or bump from a surface of the conveyor and/or one or more spray nozzles for treating metal parts that have been placed on the conveyor.

Another embodiment is a method of painting hot metal parts, comprising:
providing a concentrated anionic polymer at more than 40% wgt/vol in water at a pH above 7; diluting the anionic polymer in water to less than 5% wgt/vol and in volatile base wherein the base concentration exceeds 2% vol/vol; spraying the diluted polymer solution onto metal parts that have a mean temperature of between 400 and 600 degrees F.; and allowing the sprayed metal parts to air dry. In an embodiment, the concentrated anionic polymer is at more than 65% wgt/vol in water. The volatile base may be an alcohol alkyl amine. Another embodiment further comprises the step of collecting overspray and adding the overspray to the diluted polymer solution for reuse.

Another embodiment is a method of preparation and use of a thermoplastic paint for coating hot parts, comprising providing a first aqueous solution of at least 50% wgt/vol anionic polymer; adding a solution of non-polymeric polyfunctional amine into the first aqueous solution to at least 1 percent wgt/vol to form a anionic polymer-polyfunctional amine solution; applying the anionic polymer-polyfunctional amine solution to a metal part wherein the metal part has an average temperature of between 212 degrees Fahrenheit and 700 degrees Fahrenheit; and allowing the applied solution to air dry from heat from inside the part. The first solution additionally may comprise a monovalent amine at more than 0.5% wgt/vol and the first aqueous solution may comprise at least 75% wgt/vol anionic polymer. Furthermore, the solution of polyfunctional amine may be at a concentration of at least 25% wgt/vol, the anionic polymer-polyfunctional amine solution may be applied to metal parts that have an average temperature of at least 500 degrees, and the air drying step is may be carried out in the absence of added heat or forced air drying. Still further, the temperature of the anionic polymer-polyfunctional amine solution and the temperature and size of the metal parts may be adjusted so that the parts cool by 40-60 degrees during the air dry step. The term “air dry” means the ability to touch the treated object with a hand or hand with absestos glove without paint sticking to the hand or glove.

In an embodiment, the solution of non-polymeric polyfunctional amine further may comprise a monovalent amine of at least 0.5% wgt/vol. The first aqueous solution may further comprise at least 0.1% wgt/vol volatile base and additionally may comprise a monovalent amine at more than 0.5% wgt/vol.

Another embodiment provides a split conveyor system for a one component painting treatment of hot parts; comprising: a supply input of parts, a double-parallel conveyor comprising a left conveyor portion and a right conveyor portion, wherein the conveyor portions comprise mostly open spaces to allow paint spray transit through them, the conveyor portions separated by a 0.5 to 8 inch space between them, and a spraying system adapted to spray parts on the double parallel conveyor, comprising a reservoir of a single component spray paint. The spray paint may comprise an aqueous solution of thermoplastic polymer and volatile base. The open spaces of the conveyor portions may comprise meshes with opening sizes that exceed 0.25 inches, the split conveyor system may comprising a manual adjust of conveyor speed, and may comprise one or more spray nozzles located below the split conveyor surface and oriented to spray up.

Another embodiment provides a method of painting hot parts, comprising:
providing an aqueous solution of at least 50% wgt/vol of one or more polymers that comprise acetoacetoxy-type functional pendant moieties and acid functional moieties, and a non-polymeric polyfunctional amine having at least two amine-functional moieties, and an amount of base for inhibiting gellation in the absence of evaporation; spraying the aqueous solution onto hot metal parts that are moving on a conveyor; and allowing the sprayed parts to dry in the absence of added heat, wherein the hot metal parts on the conveyor have a mean temperature of between 250 and 800 degrees centigrade. The acetoacetoxy-type functional pendant moieties and the acid functional moieties may be provided on the same polymer, and the base may be a volatile base selected from the group consisting of ammonia, morpholine, a lower alkyl amine, 2-dimethylaminoethanol, N-methylmorpholine, and ethylenediamine.

Another embodiment provides a part coating apparatus, comprising: a conveyor adapted to receive hot parts from an oven; a source of coating composition that can form a durable coating on a hot part in less than a second after coating the hot part; a sprayer to dispense the coating composition; and a mechanism for temporarily suspending a hot part moved by the conveyor in space for less than a second, wherein the sprayer is positioned to dispense the coating composition onto the hot part during temporary suspension of the hot part in space, and wherein the composition comprises a thermal setting polymer formulated to form a tack free surface on a 375 to 525 Faherenheit temperature part within one second.

### BRIEF DESCRIPTION OF THE DRAWINGS

FIG. 1 shows representative layouts of coating apparatuses according to an embodiment.

FIG. 1A is a top view of a single conveyor with a ating station.

FIG. 1B is a side view of the conveyor from FIG. 1A.

FIG. 1C shows a relationship wherein the single conveyor of FIG. 1A is adaptively coupled to a conveyor from an oven.

FIG. 2 is a top view of a coating station according to an embodiment.

FIG. 3 is a side view that shows three representive coating embodiments.

FIG. 4 is a side view of another coating embodiment.

FIG. 5 shows embodiments that provide dispensing of water and coating material.

FIG. 5A is a top view of a conveyor with submerged pump and side view of water and coating material inputs.

FIG. 5B is a side view of a conveyor with submerged pump and water and coating material inputs

### DETAILED DESCRIPTION

Temperature studies unexpectedly revealed a solid part temperature range and spray conditions that provide a thermoplastic coating on the part with greatly improved properties and in which other problems in the art were alleviated. More surprisingly, it was found that if (using a beginning homogeneous part temperature of 460 F.) parts cooled between 40 and 100 F. (preferably 60-85 F.) could be coated very quickly, and parts from an oven temperature of 600 F. cooled between 60 and 140 F. (preferably 75 to 115 F.) could be coated very quickly. In another embodiment, coating conditions that caused a maximum drop of 55 F. for parts from a 460 F. oven, and a maximum drop of 65 F. for parts from a 600 F. oven gave surprisingly fast coating. So fast, in fact that a rapid split-second suspension technique could be used to obtain good coating. These narrow ranges were very unexpected but allowed new, rapid techniques for assembly line polymer coating that in many embodiments, require less than 1 second dry time.

Rapid assembly line coating of partially cooled parts from an oven was possible using a very brief suspension via dropping the part through a curtain of spray onto another conveyor, bumping the conveyor, or by another method for causing the part to leave the conveyor belt surface for a split-second. Yet another discovery provided even polymer coating via conveyance on a split conveyor, and spraying at least partially, through the conveyor from the bottom. Such conditions allowed complete and very fast covering of parts on a conveyor, with almost immediate dry times of less than 5 seconds particularly less than 1 second and more particularly less than 0.25 seconds in some embodiments. The term “dry” in this context means that the part can be picked up (with asbestos glove for example) without leaving a mark on the glove.

During studies on spray coating, equipment configurations and conditions were found that provided unusually good coating and part condition, which minimized drying time and yielded higher output and quality. The new methods allowed real time and rapid manual control of coating conditions to optimize coating for different parts. From studies with conveyor systems, mechanical discoveries led to improved coating.

In one such discovery the combined use of two parallel conveyors separated by a gap with coating applied from below allowed good coverage. Using this double conveyor system, a conveyor/curtain coating system was found that provides unexpectedly good performance.

In particular, these coating schemes resulted in a smoother coating on the bottom portion of the parts. In a related embodiment, the unexpectedly high surface temperature remaining after drying of the paint was capitalized by subjecting the painted parts to a second coating, which optionally may employ non-aqueous solvent, for imparting further salt water resistance to the parts.

Yet another embodiment provides more convenient and lower cost distribution of paint, based on a surprising discovery. While evaluating irreversible sludge formation of coating solutions used for immersion coating of hot parts, it was unexpectedly found that an “irreversibly” precipitated unusable product could be resuspended long enough for use in a spray system. From this serendipity, a system of coating formulation, distribution and use was derived that provides enhanced economics for use in a spray method. According to this scheme, a simple coating formulation with very high (typically more than 50%) solids is prepared without need for long term suspendability. This formulation is shipped to an end use site, where a small amount of another component (preferably a non-polymeric multi amine compound) and water are further added, and mixed to achieve at least short term (e.g. less than 1 month, 1 week or one day) suspension of solids. The suspension is then used as described herein. By adding the second component at place of use, transport costs are lessened, as less water is shipped.

These methods and devices are described in more detail next.

Coating Compositions

A coating composition is a polymeric material that usually includes a pigment. The composition optionally includes additives for helping maintain a suspension, a biocide(s), polymerization initiator or enhancer, a buffer and the like as are known to skilled artisans.

A wide range of coating compositions are contemplated for spraying onto hot parts as exemplified below. In many embodiments, the coating compositions comprise polyanionic solids and volatile base(s) and are used to coat metal surfaces. The use of acrylates on steel is particularly preferred.

Most preferred are compositions that use complex formation between amine groups (preferably non-polymeric polyfunctional amines) and acid functional groups, and preferably further contain acetoacetoxy-type functional groups. See for example U.S. Pat. No. 5,605,952 issued to Richard Esser and U.S. Pat. No. 6,090,882 issued to David Trumbo and Paul Gloor, the compositions of which particularly are incorporated by reference. In an embodiment, the composition comprises only one polymer, such polymer having both acid-functional as well as acetoacetoxy-type functional pendant moieties. In another embodiment the composition has two or more such polymers wherein one has only acid-functional pendant moieties and the other has only acetoacetoxy-type functional pendant moieties.

Still another preferred ingredient of the composition-of-matter or formulation according to an embodiment, is a so-called “non-polymeric” polyfunctional amine-containing compound having at least two amine-functional moieties.

In another embodiment the coating composition comprises an anionically stabilized binder polymer, a vinylamine polymer and a volatile base, such as described in U.S. Pat. No. 7,314,892 issued to Hermes and assigned to Rohm and Haas. In this embodiment the volatile base is at a concentration sufficient to deprotonate the conjugate acid of the amino groups of the vinylamine polymer. Typically, 20 to 100 mole % of the amino groups of the vinylamine polymer are deprotonated, preferably 60 to 100 mole %, more preferably 80 to 100 mole %, and most preferably 90 to 100 mole %. The presence of the vinylamine polymer in deprotonated form is desirable if the coating composition is to remain stable during storage, shipping, and handling. In an embodiment, however, the vinylamine polymer is shipped in at least partly protonated form and re-dissolved by addition of base before use. Preferably the polymer is shipped in a concentration (wgt/vol) that exceeds 50% (eg. 50 grams per 100 ml), 60% , 70% or even higher.

Without wishing to be bound by any one theory of operation for this embodiment, it is thought that the deprotonated amino groups do not bear a charge and, as such, do not interact with the anionic surfactant used to stabilize the emulsion polymer. Once the aqueous coating composition is applied to the surface of a substrate, the volatile base evaporates from the coating. As the volatile base escapes, the amino groups of the vinylamine polymer become protonated to form a conjugate base which is an ammonium cation. The resultant cationic vinylamine polymer then interacts with the anionic surfactant to destabilize the emulsion polymer and, as a result, the coating composition. In that way, accelerated drying is achieved. In an embodiment, typically, 5 to 100 mole % of the amino groups of the vinylamine polymer become protonated, forming ammonium groups, as the volatile base evaporates from the aqueous coating composition as it dries on the substrate surface to become a coating. Preferably the percent of amino groups of the vinylamine polymer that become protonated is 10 to 100 mole %, more preferably 40 to 100 mole %, and most preferably 80 to 100 mole %.

The vinylamine polymers in this embodiment desirably are unique polyamine functional polymers. Conventional polyamine functional polymers known to the art include, for example, aminoalky vinyl ethers and sulfides; (meth)acrylamides and (meth)acrylic esters, such as dimethylaminoethyl (meth)acrylate, bearing amine functionality; and PEI. Poly(vinylamine) homopolymer, PVAm, itself is higher in nitrogen content than all conventional polyamine functional polymers, with the exception of PEI, which has the same nitrogen content. Although PVAm and PEI have the same number of amino groups, the amino groups of PVAm are primary amine groups and, as such, are less sterically hindered, and more readily accessible than those of PEI, with the result that protonated PVAm is more efficient at destabilizing the anionic emulsion polymer to accelerate drying.

Upon application of the coating composition to the surface of a substrate, the volatile amine evaporates, and the amine groups of poly(vinylamine) homopolymer become protonated to form ammonium salts. Due to its higher nitrogen content, the protonated pVAm thus formed has a higher charge density than conventional polyamine functional polymers. This higher charge density translates into higher efficiency when the protonated poly(vinylamine) homopolymer interacts with the centers of negative charge on the anionic surfactants. As a result, destabilization of a given anionically stabilized latex may be achieved with reduced levels of pVAm. Further, this enhanced efficiency is conferred to N-substituted and N,N-disubstituted vinylamine polymers when compared with other polyamine functional polymers having identical substituents on nitrogen, and to vinylamine copolymers (co-pVAms) when compared to other polyamine functional co-polymers having identical levels of co-monomer present as polymerized units.

Optional additional ingredients include polymeric thickeners, polymeric flow-modifying ingredients, and various dispersion or emulsion polymers as well as various solution polymers.

A desirable formulation further includes “base,” in an amount that is effective for providing storage stability. The composition additionally includes an evaporable carrier. The evaporable carrier may consist essentially of water, or may comprise water and at least one additional volatile liquid that evaporates (preferably at room temperature), wherein the total amount of volatile organic compounds (“VOCs”) in the formulation does not exceed 200 grams per liter of the formulation.

low-VOC, water-based compositions may contain only one polymer or may contain at least two polymers. If only one, the polymer preferably possesses both acid-functional as well as acetoacetoxy-type functional pendant moieties. If more than one polymer types, one polymer preferably has acid-functional pendant moieties and another polymer has acetoacetoxy-type functional pendant moieties. In the former case, the polymer has acid functionality sufficient to provide an acid number in the range of about 30 to about 300. The weight-average molecular weight (“Mw”) value of such polymer typically is between about 2,000 and 50,000. In this regard, the term “acid number” indicates the number of milligrams (“mg”) of potassium hydroxide (“KOH”) required to neutralize one gram of the polymer.

Furthermore, the polymer, in the former case, preferably has an acid number in the range of about 50 to about 150. In an embodiment, the acid value of the polymer is above about 80 milligrams of KOH per gram of polymer solids, preferably above 100 milligrams of KOH and more preferably above 120 milligrams of KOH per gram of polymer solids. Also, the polymer, again in the former case, preferably has an Mw value of about 2,000 to about 40,000 and more preferably of about 2,000 to about 30,000.

However, in the latter case, there are at least two different polymers and the polymer having only acetoacetoxy-type functional pendant moieties typically has an Mw value of about 2,000 to about 1,000,000. Preferably, the Mw value is between about 5,000 and about 500,000; more preferably, the Mw value is between about 15,000 and about 300,000; and most preferably, the Mw value is between about 50,000 and about 200,000.

Also, with respect to the latter case, the polymer possessing only acid functionality, which resembles the polymer of the former case, particularly with respect to acid number ranges, may only be polymeric in structure. In particular, such a polymer also preferably has an acid number in the range of about 50 to about 150 as well as an Mw value of preferably about 2,000 to about 40,000, more preferably about 2,000 to about 30,000.

In an embodiment, the “non-polymeric” polyfunctional amine-containing compound (possessing at least two amine-functional moieties) typically has a chemical-formula weight of less than about 2,000 grams per mole, and preferably has a chemical-formula weight of less than about 1,000 grams per mole.

In an embodiment the acid value of the polymer should be between about 30 and 300, and it is preferred that the acid value of the polymer be between about 50 and 150, which will typically provide an alkali-soluble or alkali-swellable polymer. Since the viscosity of the aqueous composition-of-matter or formulation is very molecular-weight dependent, preferably the molecular weight range of the emulsion polymer is relatively low, in order to maintain desired, low viscosity values at practical “solids” levels.

The weight-average molecular weight (“Mw”) of the emulsion polymer in an embodiment should thus be in the range of between about 2,000 and 50,000, and preferably in the range of between about 2,000 to about 40,000, and more preferably in the range of between about 2,000 to about 30,000.

For purposes of dissolving such a polymer in the aqueous carrier, ammonia, an amine, an alkali metal hydroxide, or various combinations of these may be used, if desired. Suitable amines include but are not limited to methyl amine, dimethyl amine, trimethyl amine, ethyl amine, diethyl amine, triethyl amine, propyl amine, dipropyl amine, butyl amine, and combinations thereof. The term “propyl” in this context includes n-propyl, isopropyl and combinations of these, and that the term “butyl” may include n-butyl, sec-butyl, tert-butyl and combinations of these, and so forth. Accordingly, non-polymeric polyfunctional amines suitable for embodiments thus include aliphatic and cycloaliphatic amines having 2 to 10 primary and/or secondary amino groups and 2 to 100 carbon atoms.

Still further, suitable non-polymeric polyfunctional amines include but are not limited to hexamethylene diamine (“HMDA”); 2-methyl pentamethylene diamine; 1,3-diamino pentane; dodecane diamine; 1,2-diamino cyclohexane; 1,4-diamino cyclohexane; para-phenylene diamine; 3-methyl piperidine; isophorone diamine; bis-hexamethylene triamine; diethylene triamine (“DETA”); and combinations thereof.

Other non-polymeric polyfunctional amines, which are suitable, include those containing adducts of ethylene and propylene oxide, such as the “JEFFAMINE” Series of “D”, “ED” and “T” of Texaco Chemical Company of Houston, Tex., U.S.A. (See, e.g., the inside front covers of the 6 May and 24 Jun., 1991, issues of Chemical & Engineering News, published by the American Chemical Society.)

Preferred non-polymeric polyfunctional amines include 2 to 4 primary amino groups and 2 to 20 carbon atoms. Particularly preferred non-polymeric polyfunctional amines include hexamethylene diamine (“HMDA”), diethylene triamine (“DETA”), and combinations thereof.

A skilled artisan is a chemist with at least two years of experience in formulating paints, and can select a variety of compositions for use in embodiments. An exhaustive list of chemistries would be too large to present here. For example, water-reducible organofunctional silane, particularly an epoxy functional silane as a binding agent, may be used, as described in U.S. Pat. No. 5,868,819, the compositions of which most particularly are incorporated by reference.

### Volatile Base

Many embodiments and particularly single package embodiments contemplate the use of a volatile base. The volatile base of preference is ammonia, which may be used as the sole volatile base or in admixture with other volatile or nonvolatile bases. Exemplary volatile bases useful in embodiments include, for example, ammonia, morpholine, the lower alkyl amines, 2-dimethylaminoethanol, N-methylmorpholine, ethylenediamine, and others.

### Additional Ingredients

Generally, additional components may be added to the coating composition to form the final formulation for coating hot parts. These additional components include, for example, thickeners; rheology modifiers; dyes; sequestering agents; biocides; dispersants; pigments, such as, titanium dioxide, organic pigments, carbon black; extenders, such as calcium carbonate, talc, clays, silicas and silicates; fillers, such as glass or polymeric microspheres, quartz and sand; anti-freeze agents; plasticizers; adhesion promoters such as silanes; coalescents; wetting agents; surfactants; slip additives; crosslinking agents; defoamers; colorants; tackifiers; waxes; preservatives; freeze/thaw protectors; corrosion inhibitors; and anti-flocculants. During application of the aqueous coating composition to the surface of a substrate, glass or polymeric microspheres, quartz and sand may be added as part of the coating composition or as a separate component applied to the surface in a separate step simultaneously with, before, or after the step of application of the aqueous coating composition.

In particular, one or more surfactants may be included. If several are used, one typically may be a non-ionic emulsifier, at least one anionic emulsifier, or a mixture of non-ionic and anionic emulsifiers may be used. Cationic emulsifiers as well as amphoteric emulsifiers may also be used.

Examples of useful anionic surfactants are organosulfates and sulfonates, for example, sodium and potassium alkyl, aryl and alkaryl sulfates and sulfonates, such as sodium 2-ethyl hexyl sulfate, potassium 2-ethyl hexyl sulfate, sodium nonyl sulfate, sodium lauryl sulfate (“NaLS”), potassium methylbenzene sulfonate, potassium toluene sulfonate, and sodium xylene sulfonate; so-called “higher” fatty alcohols, for example, stearyl alcohols, lauryl alcohols, and so forth, which have been ethoxylated and sulfonated; dialkyl esters of alkali metal sulfosuccinic acid salts, such as sodium or potassium diamyl sulfosuccinates, in particular sodium dioctyl sulfosuccinate; various formaldehyde-naphthalene sulfonic acid condensation products; alkali metal salts, as well as so-called “partial” alkali metal salts, and free acids of complex organic phosphate esters; and combinations thereof.

Examples of non-ionic surfactants are polyethers, for example, ethylene oxide and propylene oxide condensates which include straight and/or branched chain alkyl and alkaryl polyethylene glycol and polypropylene glycol ethers and thioethers; alkyl-phenoxy poly(ethyleneoxy) ethanols having alkyl groups containing from about 7 to about 18 carbon atoms and having from about 4 to about 240 ethyleneoxy units, such as heptyl-phenoxy poly(ethyleneoxy) ethanols, nonyl-phenoxy poly(ethyleneoxy)ethanols, and so forth; the polyoxy-alkylene derivatives of hexitol, including sorbitans, sorbides, mannitans, and mannides; partial so-called “long” chain fatty-acid esters, such as the polyoxyalkylene derivatives of sorbitan monolaurate, sorbitan monopalmitate, sorbitan monostearate, sorbitan tristearate, sorbitan monooleate, and sorbitan trioleate; the condensates of ethylene oxide with a hydrophobic base, such as a base that is formed by condensing propylene oxide with propylene glycol; sulfur-containing condensates, for example, those prepared by condensing ethylene oxide with higher alkyl mercaptans, such as nonyl, dodecyl, or tetradecyl mercaptan, or with alkyl thiophenols wherein the alkyl group contains from about 6 to about 15 carbon atoms; ethylene oxide derivatives of long-chain carboxylic acids, such as lauric, myristic, palmitic, or oleic acids or mixtures of acids, such as so-called “tall” oil fatty acids; ethylene oxide derivatives of long chain alcohols such as octyl, decyl, lauryl, or cetyl alcohols; and combinations thereof.

The evaporable carrier preferably consists essentially of water only (e.g. all water). However, at least one other water-miscible volatile organic liquid, wherein the amount of volatile organic compounds (“VOCs”) does not exceed 200 grams per liter (and preferably less than 20 grams per liter) of the formulation may be used in embodiments. Such examples of water-miscible volatile organic liquids useful in this regard are alcohols; dialkyl ethers; ethylene and propylene glycols and their monoalkyl and dialkyl ethers; relatively low formula weight polyethylene oxides and their alkyl and dialkyl ethers (i.e., having a chemical-formula weight of less than about 200 grams per mole); dimethyl formamide; dimethyl acetamide; and combinations thereof.

In an embodiment electrically active component(s) are added that when dried, form photoactive layers for electricity generation. In an embodiment, a first active layer such as a photoelectric source or sink of electrons is coated from an aqueous suspension or solution that contains polymer. After drying, a second material with a different electronegativity characteristic is applied, preferably using a non-aqueous solvent. In an embodiment, photoelectric polymer(s) are applied in the first and or second coating. The underlying coated material may comprise a first electrode and a conductive material may be included in the second layer to serve as a second electrode.

High Solid Density Compositions for Lower Cost Distribution

During study of precipitated coating solutions, it was discovered that a coating composition could be formulated and stored at a user site with unusually high concentration(s) of polymer solid if suitable amounts of an appropriate base were mixed later. With increasing transportation costs this feature is highly advantageous.

In a desirable embodiment, a composition having at least 40%, 50%, 55%, 60%, 70% or even at least 75% by weight/volume of polymer is prepared and sent to an end user. The end user adds a small (less than 10% by volume, preferably less than 5% by volume) amount of a second component such as a base, and dilutes with water. The second component desirably is a material (for example, ammonia) that can be procured locally. In an embodiment, the composition polymer comprises a pre-crosslinked moiety such as that taught by U.S. Pat. No. 6,090,882 and the second component is a polyfunctional amine. The polyfunctional amine is mixed in before use. In an embodiment, two components are added, and preferably an amine base and a polyfunctional amine are both added.

### Methods and Apparatuses of Use

In a most desirable embodiment, apparatuses and methods described herein operate with heated parts, such as heated metal parts (heat tempered springs etc.) obtained from a furnace via a conveyor. The parts are at a temperature above the boiling point of water and are not dunked into a coating composition but are coated during at least partial suspension in air. By “partial suspension in air” is meant that a part (or portion of a part to be coated) is not in physical contact with a conveyor surface but can receive a coating spray. A variety of tools and methods were found that allow such coating and will be described.

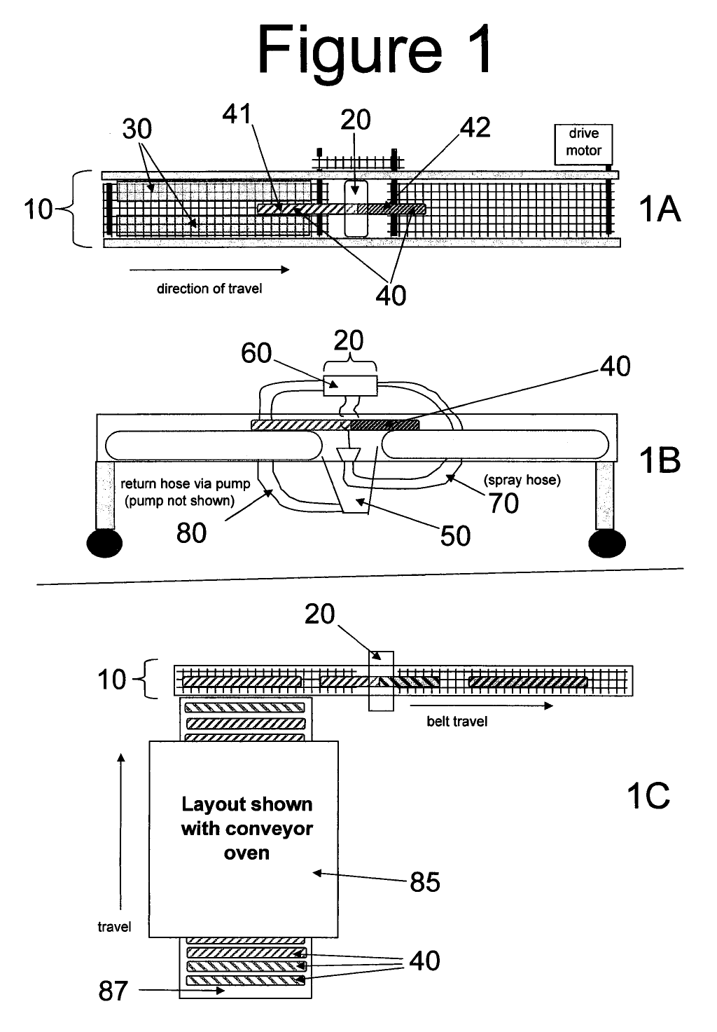

FIG. 1A is a top view of conveyor 10, with a left portion that receives hot metal parts, central coating zone 20 and a right portion that receives sprayed parts from coating zone 20. This figure shows adjustment guides 30, which shephard the parts into the long axis center of the conveyor. Part 40 is a long spring, with left hand, uncoated portion 41 and right hand, coated potion 42, extending across central coating zone 20. Portion 42 enters coating zone 20 at a slightly higher temperature than portion art 41 and a range of temperatures should be followed for optimum coating of the entire part for this reason. Also, the speed of conveyor 10 should be controlled, (manually/and or automatically) to maintain part temperature within desired ranges. For example, one or more infrared detectors may be configured to detect surface temperature at one or more locations on the part and can participate in a feedback cybernetic loop. Such loop may numerically compare a detected temperature with a table or algebreic result as desired target points, and continuously adjust conveyor speed to maintain temperatures within a range and/or assert an alarm when a process temperature limit is exceeded.

FIG. 1B shows side view detail of coating zone 20 having coating composition reservoir 50 located at a lower position to collect overspray, spray curtain 60 above moving part 40 and hose 70, which feeds spray curtain 60 from reservoir. Return hose 80 is shown on the left side.

FIG. 1C shows oven 85 with springs 40 that are positioned lengthwise along conveyor 87 and exit the top, where individual springs are picked up by second conveyor 10, which moves horizontally (to the right) in this figure. Each part thus passed to conveyor 10 transits central coating zone 20.

While studying the basic format shown in FIG. 1, it was surprisingly found that control of part temperature within a range combined with split second suspension of a part or part portion transiting the coating zone allowed extremely rapid drying of a thermosetting composition such as described herein. In fact, upon exiting the coating zone, a part usually can be handled immediately without tackiness.

A further benefit of this rapid coating of heated parts, is the ability to further exploit the heat from the part, in a second coating step (not shown in the figures). A second coating step could utilize an aqueous based composition but more preferably uses a majority or sole solvent that has a lower boiling point than water. The second coat could, for example, provide further salt resistance, or simply provide an identification mark.

In and embodiment a first coating of water soluble material is combined with a second coating of water insoluble material to make a functional complex that allows chemical or electrical reaction between components found in both layers. Such prepared materials may be used in chemical and industrial processes such as chemical conversions and may be used for solar electric generation. For example, a water insoluble photoabsorbing dye may be deposited and allowed to react with (transfer energy or emit an electron to) another component that is supplied in the water solvent deposition layer.

Although the use of coating materials on hot metal is exemplified in most embodiments, the processes and apparatuses and materials described are useful for a much broader range of oven treated parts or even raw materials. For example, an organic solar cell based on a two part coating of a metal or other ceramic or hard material prepared in a furnace can exploit aspects. A polymer with semiconductor material for example can be laid down upon another conductor or semiconductor solid substrate. A second coating step can add a protective layer, for example. In particular, coating with an aqueous solvent based material, followed by coating with a non-aqueous based material is particularly recommended where it is desired to prevent water contact with one or more chemicals that are to be added. By coating with aqueous material first, and followed by drying, the second composition can add chemical(s) that either need to avoid water or that become activated by water. An example of the latter is a diagnostic test tool, which changes color depending on reaction between a solute and chemical agents that have been added to the tool via coating the two compositions.

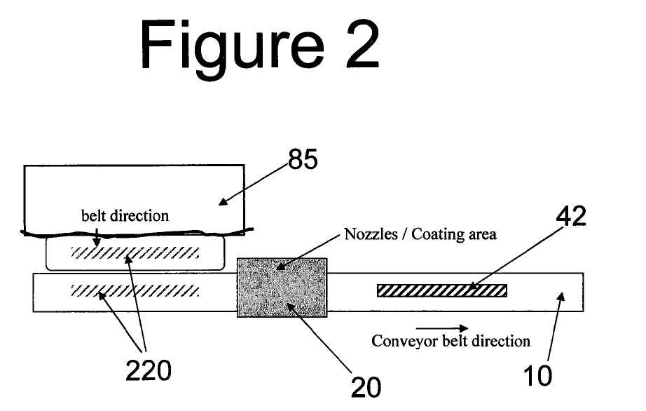

To utilize the most heat, the coating station may be positioned close to the oven, as depicted in the top view of FIG. 2. Here, end exit of conveyor oven 85 passes heat tempered springs 220 onto second conveyor 10. Each spring passes through coating station 20, which comprises a two dimensional matrix of nozzles, to yield coated part 42. It was found that such an arrangement works best if the bottom of the part that transits coating station 20 is exposed to spray.

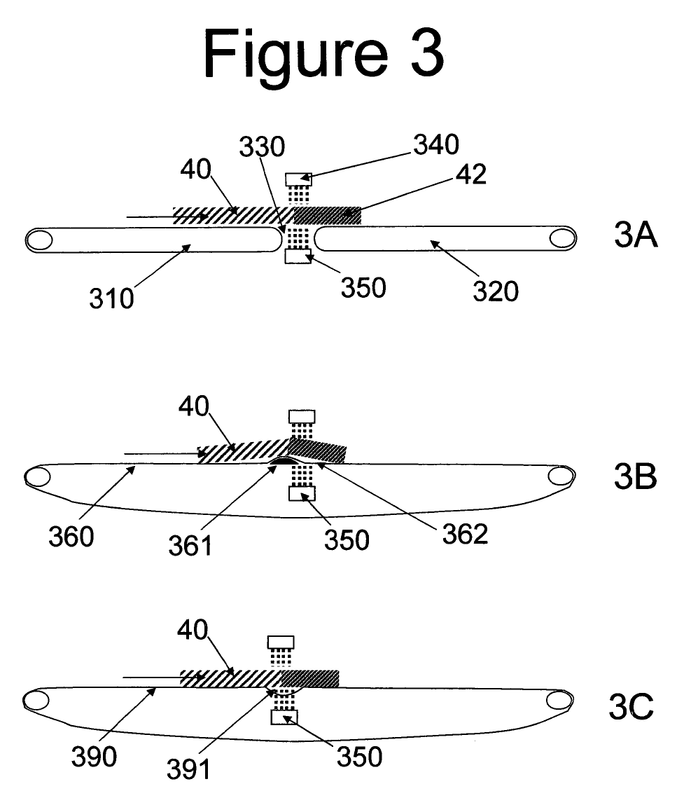

FIG. 3 shows three representative embodiments for achieving split second suspension to allow spray penetration of the bottom portion that contacts the conveyor. FIG. 3A shows hot spring 40 moving from conveyor 310 to conveyor 320 across gap 330. Spray nozzles 340 are positioned above gap 330 and spray nozzles 350 are located below gap 330. Portion 42 of hot spring 40 is located downstream from this coating station, has coating, and can already be handled, or treated with another coating step. The split second suspension of FIG. 3A is achieved by the treated part having to cross a gap between conveyors. The gap distance (along the line of travel) should be less than half of the part length.

FIG. 3b shows single conveyor 360 with bump 361 that causes a part on the conveyor to lift off and be suspended in air for at least a split second or more. This bump causes gap 362 to form below part 40 so that spray from nozzles 350 can coat the bottom portion. In most such embodiments, the coating composition itself dries in less than one second. In an embodiment, the time a part is in suspension in air is controlled to match the requirements of drying, as based on the coating composition, part temperature, conveyor speed and /or other parameters that a skilled artisan can appreciate and determine.

FIG. 3C is yet another embodiment wherein a temporary suspension in air is achieved by locating a recess in the conveyor. Conveyor 390 is adapted to form space 391 where part 40 does not contact the conveyor. Spray nozzles 350 have a less or non-obstructed spray path to the bottom of part 40.

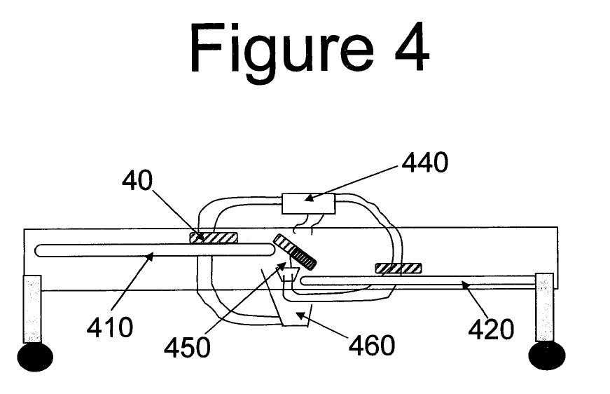

FIG. 4 shows another example of an apparatus that causes the part to suspend in air for at least a split second. This side view shows conveyor 410 at a higher elevation than and feeding conveyor 420. Three elongated parts 40 are shown, with one falling from conveyor 410 to conveyor 420 under spray nozzles 440. This figure also shows spray nozzles 450, which spray upwards, and fluid reservoir 460. Spray nozzles 440 can be a curtain sprayer.

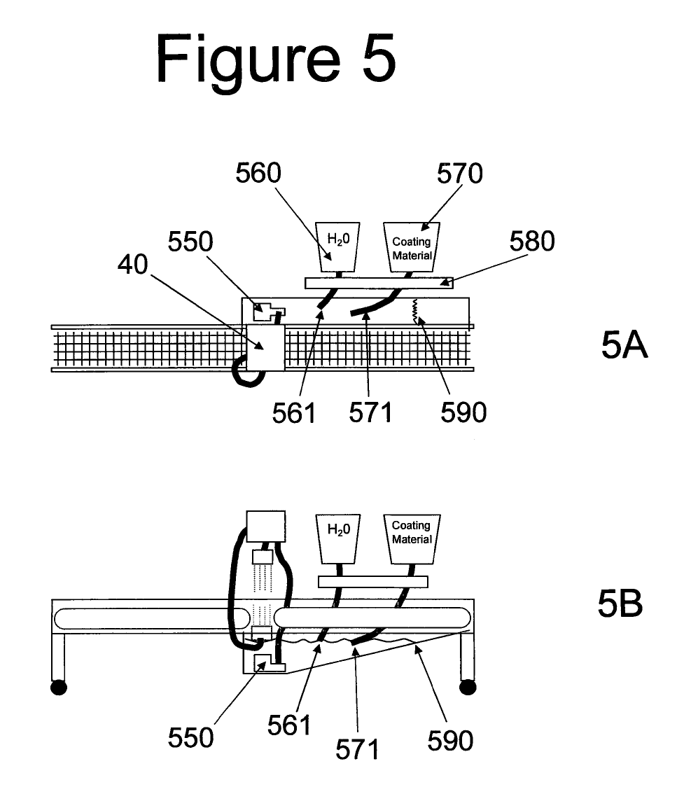

FIG. 5 shows an implementation of coating material supply wherein coating material 570 and water (or diluent which may be water plus other components) 560 are added to a reservoir below controller 580 via conduits 571 and 561 respectively. As shown, controller 580 adjusts the amount added. Not shown is an optional mixer, which desirably may be located within the reservoir. In this embodiment, pump 550, which lies within the reservoir pumps reservoir fluid up to spray dispenser 40. FIG. 5A shows a top view, with side views of 560, 570 and 580 for convenience. FIG. 5B shows a side view wherein a dispenser dispenses fluid/suspension from under conveyor via a nozzle and above the conveyor via a nozzle (nozzles located above pump 550 in the drawing).

FIG. 5B shows coating material level line 590, which indicates how much material remains in the reservoir. A control device such as a float, optical level reader, electrical switch or the like may be employed here to output a signal to control drive 580.

The embodiments and example provided here are non-limiting but serve to illustrate representative embodiments. Space considerations preclude adding other examples and the claims are not limited to these representative examples.

### Example 1

A thermoplastic paint composition as described above, sold under the tradename “Aqua-TRC coating material” was obtained.

The composition was sprayed onto hot steel parts (3 foot long garage door springs) moving on a conveyor from a thermal annealing oven at various temperatures. The following table summarizes optimum temperature ranges found that yielded tack free coatings in about 0.75 seconds. Conditions outside this range resulted in insufficient (generally non-tack free) coatings

| Part Temp. | Part Temp. | Part Temp. | |
|---|---|---|---|
| From Oven | when Coated | after Coating | Result |
| 460 F. | Less than 360 F. | Less than 270 F. | Sticky, no good |
| 460 F. | 360-420 F. | 270-360 F. | Tack Free, good |
| 460 F. | 375-400 F. | 320-345 F. | Better |
| 460 F. | Above 420 F. | Above 360 F. | Best of 460 F. group |
| 600 F. | Less than 460 F. | Less than 380 F. | Sticky, no good |
| 600 F. | 460-540 F. | 380-490 F. | Tack free, good |
| 600 F. | 485-525 F. | 420-445 F. | Best of 600 F. group |
| 600 F. | Above 540 F. | Above 490 F. | Good |

In contrast to the procedure used in the immersion technique, parts coated as described here had final temperatures when dry that were high enough for a second process step that utilized the part heat.

Other embodiments and combinations of embodiments will be appreciated by a skilled artisan upon reading the specification and are intended to be within the scope of the claims. All cited documents and particularly structural details of conveyors, sprayers, curtain sprayers, and compositions of coating materials described in cited patents and patent applications are specifically incorporated by reference in their entireties.

I claim:

1. An apparatus for coating heated metal parts without quenching, comprising:
a conveyor of metal parts from an oven, the metal parts having mean temperatures between 300 and 500 degrees Fahrenheit;
a source of aqueous polymer solution;
a dispenser fluidically connected to the polymer solution, the dispenser positioned to coat at least most of the outside surfaces of the metal parts; and a pump for moving the aqueous polymer solution through the dispenser at a controlled flow rate; wherein
the pump is controlled to dispense polymer solution onto the heated metal parts at a rate that cools the metal parts less than 100 degrees Fahrenheit until a dry state.

2. The apparatus of claim 1, wherein the aqueous polymer solution comprises a polyanionic polymer at a concentration of at least 2% weight/volume and a volatile base.

3. The apparatus of claim 2, wherein the polymer comprises acetoacetoxy-type functional moieties and the polymer solution further comprises amine-functional moieties.

4. The apparatus of claim 2, wherein the volatile base is selected from the group consisting of dimethylamino hydroxypropane, amino methyl propanol, dimethyl amino methyl propanol, dimethyl amino ethanol, diethyl amino ethanol, morpholine, polyethyleneamine and triethanolamine.

5. The apparatus of claim 1, further comprising a catch basin located below the dispenser and positioned to collect overspray.

6. The apparatus of claim 1, further comprising a second, non-aqueous solvent based polymer solution and a second dispenser fluidically connected to the second polymer solution and positioned to dispense the second polymer onto the metal parts after they have dried.

7. The apparatus of claim 1, wherein the dispenser is a spray curtain.

8. The apparatus of claim 1, wherein the aqueous polymer solution comprises a volatile base that buffer the solution with a pKa below 9.

9. The apparatus of claim 1, wherein the metal parts have mean temperatures between 300 and 500 degrees Fahrenheit.

10. The apparatus of claim 1, wherein the aqueous polymer solution comprises a stryrine acrylic polymer and a volatile base.

11. A method for coating heated metal parts without quenching them, comprising:
providing hot metal parts at mean temperatures between 300 and 700 degrees Fahrenheit via a conveyor;
spraying the metal parts with a coating solution comprising an aqueous polymer and a volatile base; and
allowing the parts to air dry, where
the spray density and conveyor movement allows cooling the parts by less than 50 degrees Fahrenheit while air drying.

12. The method of claim 11, wherein the hot metal parts are provided at mean temperatures of between 400 and 550 degrees Fahrenheit.

13. The method of claim 11, wherein the coating solution comprises a polyanionic polymer at a weight to volume ratio of between 0.5 to 15 percent, and a volatile base.

14. The method of claim 13, wherein the volatile base is a non-ammonia buffer compound with a pKa less than pH 10.

15. The method of claim 11, wherein the spraying step comprises dropping the parts through a waterfall curtain or ring tube.

16. The method of claim 15, wherein the waterfall curtain is positioned at an intersection between a first conveyor that brings the metal parts from a furnace and a second conveyor positioned horizontally below the first conveyor.

17. The method of claim 11, wherein the conveyor speed and the
spraying volume are manually controlled individually.

18. The method of claim 11, wherein the conveyor comprises two parallel conveyors with a small gap between them that is small enough to prevent the parts from falling out.

19. The method of claim 18, wherein the gap size is between 0.1 and 0.5 times the mean part diameter size, with respect to the horizontal movement axis of the part on the conveyor.

20. The method of claim 11, further comprising a computer with a stored program that controls at least conveyor speed or spraying volume rate, and which accepts user input to select an optimum speed or volume rate that corresponds with a part type.
